(19) United States
(12) Patent Application Publication
(10) Pub. No.: US 2025/0378284 A1
(43) Pub. Date: Dec. 11, 2025

(54) OFFLINE LARGE LANGUAGE MODEL FOR DRONE CONTROL AND MONITORING

(71) Applicant: Angelo Thomas Niforatos, Fayetteville, NY (US)

(72) Inventor: Angelo Thomas Niforatos, Fayetteville, NY (US)

(21) Appl. No.: 18/739,517

(22) Filed: Jun. 11, 2024

(51) Int. Cl. G06F 40/58; G05D 1/60; G05D 109/20; G06F 40/169; G06F 40/30

(52) U.S. Cl. CPC G06F 40/58; G05D 1/60; G06F 40/169; G06F 40/30; G05D 2109/20

(57) ABSTRACT

An Offline Large Language Model for Drone Control and Monitoring is disclosed. The system incorporates a smaller large language model that is trained in a much similar way, but in an offline setting to simplify drone operation, making it accessible to users with minimal training. This is especially advantageous in military contexts where quick deployment and ease of use are critical. The offline nature of the model ensures functionality in environments without reliable internet access.

### BACKGROUND OF THE INVENTION

Monitoring and controlling a drone when in use is critical. However, drones that are operated by non-hobbyists (e.g., low-cost military drones) often operate in offline settings, and are often very difficult to use. While some control software enables the operator to view and control certain aspects of the drone, these systems often only add complexity to the user experience.

The present invention relates monitoring and controlling drones. and, more particularly, to offline drone control and monitoring using a large language model. Unlike existing technologies that rely on online models, this invention operates entirely offline, ensuring reliability in remote and/or secure locations.

In contrast to existing online LLM implementations, which require continuous internet connectivity and pose privacy risks, the proposed offline LLM is designed to operate entirely within a localized environment. This ensures data security and provides real-time processing capabilities, which are critical for applications involving MAVLink commands. By pre-training the model on a specialized dataset focused on the MAVLink protocol, the offline LLM can accurately interpret and generate MAVLink commands without relying on external servers. This invention addresses the limitations of online LLMs by providing a robust, secure, and efficient solution for autonomous vehicle communication.

Developing an offline LLM that performs on par with its online counterparts required innovative solutions to several technical challenges, such as managing memory constraints and ensuring model updates without internet access. These solutions are not straightforward and require significant expertise and experimentation, demonstrating the non-obvious nature of this invention.

### SUMMARY OF THE INVENTION

The system of the present invention simplifies drone operation, making it accessible to users with minimal training. This is especially advantageous in military contexts where quick deployment and ease of use are critical. In one aspect of the present invention, the system incorporates a large language model that is trained in an offline setting. In addition, the offline nature of the model ensures functionality in environments without reliable internet access.

These and other features, aspects and advantages of the present invention will become better understood with reference to the following drawings, description, and claims.

### BRIEF DESCRIPTION OF THE DRAWINGS

FIG. 1 is a flow diagram in accordance with a preferred embodiment of the present invention; and

FIG. 2 is a flow diagram for pretraining the LLM in accordance with a preferred embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a system for monitoring and controlling drones for non-hobbyist use cases (e.g., low-cost military drones) that operate in offline settings. Such drones are often very difficult to use, and while conventional control software may enable the operator to view and control certain aspects of the drone, the conventional control software often adds to the complexity of controlling and monitoring the drone. The present invention is directed at overcoming shortcomings in the conventional drone control and monitoring systems and methods.

In a preferred embodiment, the system of the present invention is directed at incorporating an offline Large Language Model (LLM) that will utilize natural language prompts from an operator and translate those prompts into commands and queries for the drone. In a preferred embodiment, the LLM is also trained to ignore any non-related queries or commands.

The present invention differs from what currently exists. Current market offerings primarily include online model-based drone control systems. This present invention, in contrast, distinguishes itself (in part) by its offline capabilities, allowing for operation in environments without internet access and enhancing security and reliability.

Without an internet connection, conventional methods will not function as the solutions use API endpoints on the web. ChatGPT, by way of example, is much too large of a model to fit on an offline system.

The system of the present invention incorporates a smaller large language model that is trained in a much similar way. However, one of the key distinguishing differences is that in the present invention everything is done in an offline setting, thus simplifying drone operation, making it accessible to users with minimal training. This is especially advantageous in military contexts where quick deployment and ease of use are critical. The offline nature of the model ensures functionality in environments without reliable internet access.

Control Commands: In a preferred embodiment the system of the present invention can also produce control commands. More specifically, in a preferred embodiment the system of the present invention can produce specific command sequences that drones can execute, translating natural language into precise, machine-readable instructions.

Status Reports: In a preferred embodiment the system of the present invention can also produce status reports. More specifically, in a preferred embodiment the system of the present invention can generate real-time status reports and updates on the drone's condition, location, and environment in natural language, making the information easily comprehensible for the operator.

Automated Responses: In a preferred embodiment the system of the present invention can also produce automated responses. More specifically, in a preferred embodiment the system of the present invention can, in response to queries, produce automated, informative feedback regarding the drone's systems, such as battery life, signal strength, payload status, and navigational data.

Safety Alerts: In a preferred embodiment the system of the present invention can also produce safety alerts. More specifically, in a preferred embodiment the system of the present invention can generate safety alerts derived from the drone's sensors, alerting operators to potential hazards or malfunctions in a timely manner through natural language communication.

Diagnostic Data: In a preferred embodiment the system of the present invention can also produce diagnostic data. More specifically, in a preferred embodiment the system of the present invention, when used for maintenance or troubleshooting, can produce diagnostic data and recommendations, helping operators address issues without the need for complex technical knowledge.

Operation Logs: In a preferred embodiment the system of the present invention can also produce operation logs. More specifically, in a preferred embodiment the system of the present invention can generate detailed logs of operations, commands issued, and the drone's responses, which are useful for record-keeping, analysis, and improving future operations.

Interactive Training: In a preferred embodiment the system of the present invention can also produce interactive training. More specifically, in a preferred embodiment the system of the present invention can generate interactive training programs for operators, providing a natural language-based simulation of drone operations, which would be more accessible and easier to understand.

Data Analytics: In a preferred embodiment the system of the present invention can also produce data analytics. More specifically, in a preferred embodiment the system of the present invention, when equipped with data processing capabilities, could produce analytics reports from the data collected by the drone, offering insights that could be used for decision-making in various fields like agriculture, surveillance, or logistics.

Emergency Protocols: In a preferred embodiment the system of the present invention can also produce emergency protocols. In critical situations, the utility can produce a sequence of emergency protocols communicated to the operator in natural language, ensuring that the right actions are taken swiftly and effectively.

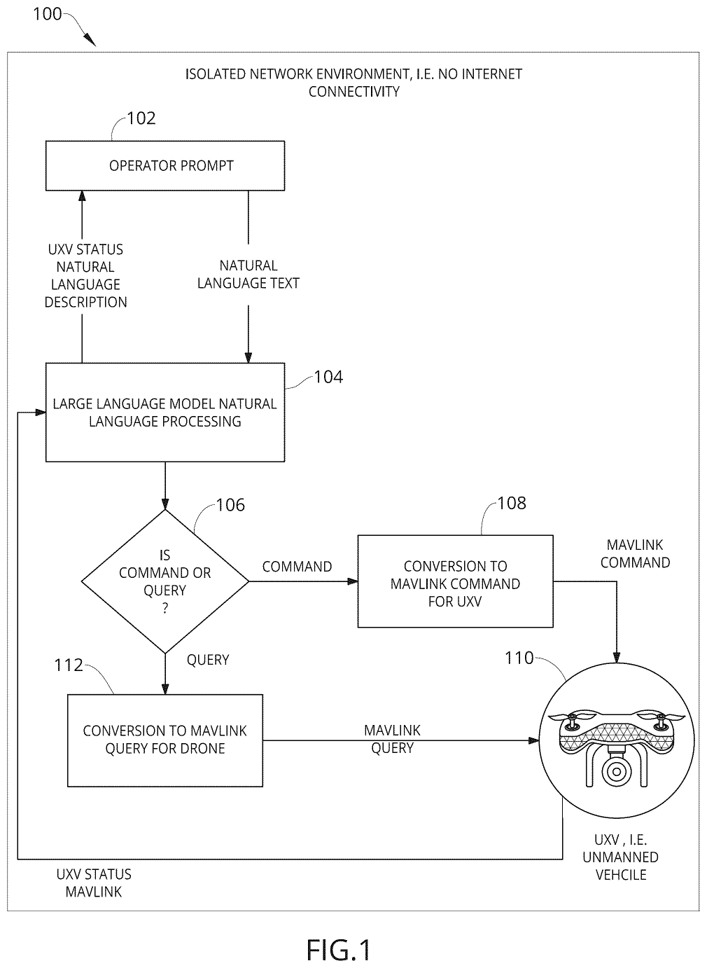

The operation of system 100 in accordance with a preferred embodiment of the present invention is further discussed below and is depicted in FIG. 1. Certain of the primary components and related functionality as seen in FIG. 1 are discussed below:

Offline State: The system's ability to operate offline is fundamental. It ensures that the language model is contained within the drone's system or a connected device without needing external internet connectivity. This enhances security and reliability, which is particularly important in military operations or remote areas.

Operator Input: The human-machine interface is designed to receive natural language prompts from the operator (102). This input can be in the form of spoken words, typed text, or other natural language interfaces. It is the starting point for the system's interactive process.

Large Language Model (LLM) and Natural Language Processing (NLP): Once the operator provides input 102, the LLM equipped with NLP capabilities processes the natural language data (104). It analyzes the structure, intent, and semantics of the operator's prompt to understand the required action. The LLM and NLP work together as the ‘brain’ of the system, translating human language into a machine-readable format. To ensure the system accurately interprets and generates MAVLink commands, the LLM is pre-trained on a comprehensive dataset specifically focused on the MAVLink protocol. This dataset includes MAVLink command sequences, usage scenarios, and annotated examples of natural language queries paired with their corresponding MAVLink commands. By pre-training the model on this specialized dataset, the LLM gains a deep understanding of the MAVLink protocol, enabling it to convert operator inputs into precise MAVLink commands effectively.

Command or Query Identification: This step involves the LLM determining whether the operator's prompt is a command for the drone to perform an action or a query requesting information (106). This decision-making capability is crucial for the system to respond appropriately to the operator's needs.

Command Conversion: If the prompt is identified as a command, the LLM translates it into a specific command that the drone's control system can understand (108), typically in a standardized protocol like MAVLink (Micro Air Vehicle Link). This translation is akin to an interpreter translating one language to another.

Query Conversion: If the prompt is a query, the LLM similarly converts it into a data request that the drone can process (112). This could involve accessing sensors or status information within the drone's systems.

Drone Action or Response: The drone receives the translated command or query and performs the corresponding action or gathers the requested data. This involves the drone's mechanical and electronic components executing the command or retrieving and processing information.

Feedback to Operator: The feedback or data from the drone is then translated back into natural language by the LLM and communicated to the operator. This step closes the interactive loop, providing a seamless and intuitive user experience.

System Remains Offline: Throughout this process, the system maintains its offline state, ensuring that operations can be carried out without the need for an internet connection.

Individually, each step serves a specific function, from receiving input to processing and executing commands. Collectively, these steps form an integrated workflow that allows a human operator to interact with a drone using natural language in a secure, offline environment. The smooth interplay between these components fulfills the invention's purpose of making drone operations more accessible and efficient, especially in conditions where traditional control methods may not be practical or available.

To further enable the functionality contemplated herein, certain of the primary components are further discussed below:

Drone Equipment: The drone must be equipped with the necessary sensors, communication hardware, and actuators to perform tasks and gather data. Computing Module: A Graphics Processing Unit (GPU) with sufficient processing power must be on board a portable ground control unit to run the offline large language model (LLM) and natural language processing (NLP) software.

Input Interface: The system needs a user interface for the operator to input natural language prompts, which could be a microphone for voice commands or a keyboard for typed input. These commands do not have to follow a specific format, they must contain enough detail to properly convert it to a command for the drone. For example, if an operator decides to send a drone to a specific location, then coordinates shall be provided by the operator to the LLM.

Output Interface: For feedback to the operator, the system might include a display screen, speakers, or other notification systems to convey information in natural language.

### Software Development:

LLM and NLP Integration: Integrate the large language model with NLP capabilities into the system's software so that it can process natural language inputs.

Control Software: Ensure the drone's control software can interpret and act on the commands generated by the LLM. This may involve mapping LLM outputs to specific drone control protocols.

User Interface Software: Implement user interface software that is intuitive and allows for easy input of prompts and display of feedback.

The necessary elements are the Computing Module, Large Language Model, Input Interface, Output Interface, Drone Control Software, User Interface Software. The physical drone itself is optional, as simulated drones can be used instead.

In addition to the benefits noted above, the system of the present invention provides numerous benefits over conventional systems and methods, including the following:

Ease of Use: Operators use natural language to control the drone. Instead of learning complex control systems or command syntax, they simply speak or type requests as if they were communicating with another person. This reduces the learning curve and operational complexity.

Offline Operation: In areas without reliable internet, your solution remains functional since it does not rely on cloud-based processing. This is critical for military operations, disaster relief efforts, or any situation where connectivity is compromised.

Command Translation: When an operator issues a command (“Take off and head north”) or asks a question (“What is the battery status?”), the offline large language model interprets the intent and translates it into actionable commands or queries that the drone's systems can execute.

Drone Control: The translated commands are fed to the drone's control system, prompting it to perform the desired actions such as taking off, moving in a specific direction, hovering, capturing images, etc.

Feedback Interpretation: If the operator's input is a query, the system retrieves the relevant data from the drone (like battery status or GPS coordinates), which is then translated back into natural language and communicated to the operator, providing an update on the drone's status or the environment it's surveying.

Military Use: In military settings, soldiers without specialized drone piloting skills can deploy and manage drone operations.

Security: Since the solution works offline, it offers a higher degree of security. There is less risk of interception or hacking compared to systems that rely on cloud processing.

Adaptation and Flexibility: Your solution can be adapted for different types of drones and missions, making it versatile for various scenarios. New commands and queries can be programmed into the language model as needed for specific operations.

Additionally: General Vehicle Operations: Drivers or operators could issue natural language commands to control various aspects of the vehicle's operation, such as starting the engine, adjusting the climate control, or setting a navigation destination.

Maintenance Queries: Operators could ask about the vehicle's maintenance status or require diagnostics using conversational language, and the system would provide updates or alerts in natural language.

Safety Protocols: In a critical situation, such as when sensors detect potential hazards, the system could communicate with the driver or passengers using natural language to explain the situation and advise on safety measures.

Accessibility Features: This technology could enhance accessibility for individuals with disabilities by allowing them to interact with the vehicle's systems through voice commands, thus providing a more inclusive user experience.

Emergency Response: The system could be used in emergency response vehicles to quickly and intuitively control vehicle functions or to gather information about the environment, operational status, or navigation without the need for complex control panels or interfaces.

Fleet Management: In a logistics setting, fleet operators could use natural language commands to coordinate autonomous vehicles, optimize routes, or check the status of deliveries without relying on internet connectivity.

It should be understood, of course, that the foregoing relates to exemplary embodiments of the invention and that modifications may be made without departing from the spirit and scope of the invention as set forth in the following claims.

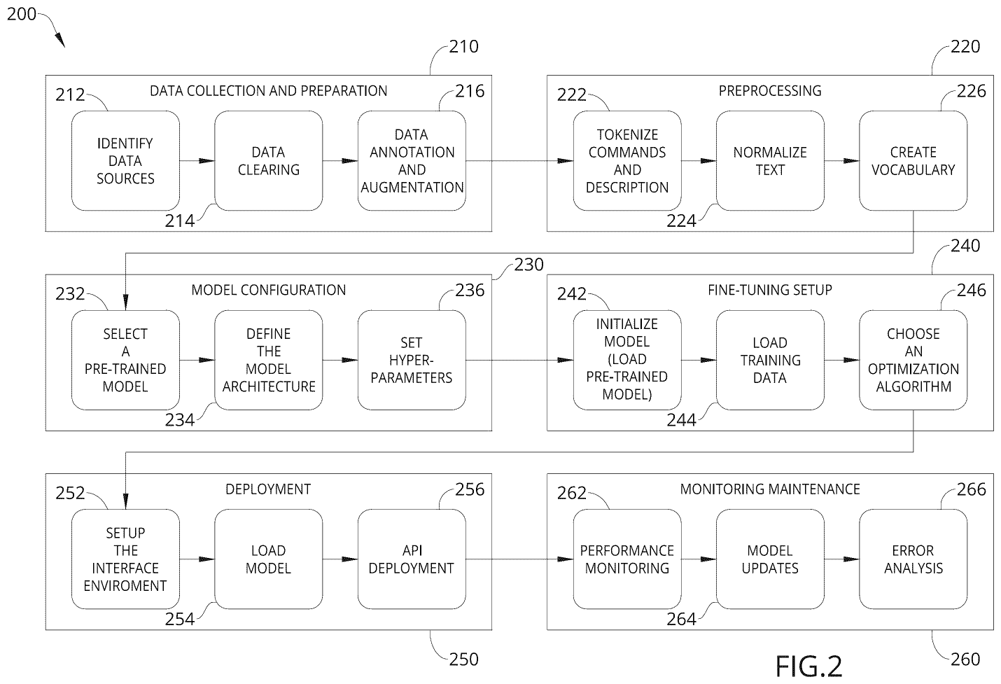

FIG. 2 depicts the process flow 200 for pre-training the LLM. As seen therein, the primary functional blocks comprise data collection and preparation (210), preprocessing (220), model configuration (230), fine-tuning setup (240), deployment (250) and monitoring and maintenance (260). Specific elements within each of these functional blocks are discussed in more detail below.

Identify Data Sources (212): Gather MAVLink command sequences, usage scenarios, and additional related datasets from patents, official MAVLink documentation, and open-source projects.

Data Clearing (214): Remove duplicates and irrelevant data, and normalize command syntax to ensure consistency and accuracy.

Data Annotation and Augmentation (216): Annotate MAVLink commands with corresponding natural language descriptions to create a comprehensive training dataset. Generate additional training data by paraphrasing and modifying existing command sequences to enhance model robustness.

Tokenize Commands and Description (222): Split the collected text into tokens for both commands and descriptions, facilitating the model's understanding of the data structure.

Normalize Text (224): Standardize text format by converting all text to lowercase and ensuring consistent syntax, preparing the data for training.

Create Vocabulary (226): Build a specialized vocabulary that includes tokens specific to MAVLink commands and natural language descriptions, aiding in precise model training.

Select Pre-Trained Model (232): Choose an appropriate pre-trained model (e.g., GPT4All) that can be fine-tuned for MAVLink commands.

Define Model Architecture (234): Ensure the model architecture is suitable for fine-tuning, including the number of layers, attention heads, and other parameters.

Set Hyperparameters (236): Define hyperparameters such as learning rate, batch size, and the number of epochs to optimize the training process.

Initialize Model Weights (242: Load the pre-trained model weights, providing a strong starting point for fine-tuning.

Load Training Data (244): Batch load the annotated MAVLink command sequences into the training pipeline to prepare for the fine-tuning process.

Choose Optimization Algorithm (246): Select an optimization algorithm (e.g., Adam optimizer) to efficiently update model weights during training.

Set Up Inference Environment (252): Configure the hardware (CPU/GPU) for running the model in the target deployment environment.

Load Model (254): Load the fine-tuned model into the inference environment to prepare for real-time operation.

API Development/Deployment (256): Develop and deploy the APIs that allow natural language input and return MAVLink command output, facilitating easy integration with other systems.

Performance Monitoring (262): Continuously monitor the model's performance in the deployment environment, tracking latency and accuracy.

Model Updates (264): Periodically retrain the model with new MAVLink data to maintain and improve its performance.

Error Analysis (266): Investigate any errors or discrepancies in the model's outputs and refine the model accordingly.

It should be understood, of course, that the foregoing relates to exemplary embodiments of the invention and that modifications may be made without departing from the spirit and scope of the invention as set forth in the following claims.

What is claimed is:

1. A method of monitoring and controlling a drone in an offline setting, the method comprising:
inputting natural language prompts from an operator via a human-machine interface'
processing the natural language prompt by a large language model (LLM) present on the drone;
determining whether the operator's natural language prompt is a command for the drone to perform an action or a query requesting information;
if the prompt is identified as a command, translating the prompt by the LLM into a specific command that the can understand;
if the prompt is a query, converting the query by the LLM into a data request that the drone can process;
wherein the drone receives the translated command or converted query and performs a corresponding action; and
wherein feedback or data from the drone is then translated back into natural language by the LLM and communicated to the drone operator.

2. The method according to claim 1, wherein the natural language prompt is spoken words from the operator.

3. The method according to claim 1, wherein the natural language prompt is typed text from the operator.

4. The method according to claim 1, wherein the LLM analyzes the structure, intent, and semantics of the operator's prompt to understand the required action.

5. The method according to claim 1, wherein the step of converting the query comprises accessing sensors or status information from the drone.

6. The method according to claim 1, wherein the corresponding action comprises mechanical and electronic components on the drone.

7. A method of pre-training a Large Language Model for monitoring and controlling a drone in an offline setting, the method comprising:
gathering MAVLink command sequences, usage scenarios, and additional related datasets;
removing duplicates and irrelevant data, and normalizing the command syntax to ensure consistency and accuracy;
annotating the MAVLink commands with corresponding natural language descriptions to create a comprehensive training dataset;
splitting the collected text into tokens for both commands and descriptions to facilitate the model's understanding of the data structure;
standardizing the text format by converting all text to lowercase and ensuring consistent syntax to prepare the data for training;
building a specialized vocabulary that includes tokens specific to the MAVLink commands and natural language descriptions to aid in precise model training;
choosing an appropriate pre-trained model that can be fine-tuned for the MAVLink commands;
ensuring the model architecture is suitable for fine-tuning, including the number of layers, attention heads, and other parameters;
defining hyperparameters such as learning rate, batch size, and the number of epochs to optimize the training process;
loading the pre-trained model weights to provide a strong starting point for fine-tuning;
batch loading the annotated MAVLink command sequences into the training pipeline to prepare for the fine-tuning process;
selecting an optimization algorithm to efficiently update model weights during training;
configuring hardware for running the model in the target deployment environment;
loading the fine-tuned model into the inference environment to prepare for real-time operation;
developing and deploying APIs that allow natural language input and return MAVLink command output to facilitate easy integration with other systems;
monitoring the model's performance in the deployment environment, tracking latency and accuracy;
periodically retraining the model with new MAVLink data to maintain and improve its performance; and
investigate any errors or discrepancies in the model's outputs and refine the model accordingly.
